(19) United States
(12) Patent Application Publication
(10) Pub. No.: US 2020/0058252 A1
(43) Pub. Date: Feb. 20, 2020

(54) DISPLAY DRIVING CIRCUIT AND OPERATING METHOD THEREOF

(71) Applicant: SAMSUNG ELECTRONICS CO., LTD., Suwon-si (KR)

(72) Inventors: Jung-moon Kim, Seoul (KR); Seung-hee Kuk, Hwaseong-si (KR); Si-woo Kim, Suwon-si (KR); Won-seok Kim, Seongnam-si (KR); Yeong-shin Jang, Osan-si (KR)

(73) Assignee: SAMSUNG ELECTRONICS CO., LTD., Suwon-si (KR)

(21) Appl. No.: 16/456,304

(22) Filed: Jun. 28, 2019

(30) Foreign Application Priority Data
Aug. 14, 2018 (KR) 10-2018-0095162

(51) Int. Cl. G09G 3/3233; G09G 3/3258; G09G 3/3266; G09G 3/3275

(52) U.S. Cl. CPC G09G 3/3233; G09G 3/3258; G09G 2320/029; G09G 3/3275; G09G 3/3266

(57) ABSTRACT

A display driving circuit is provided. The display driving circuit includes: an input control circuit configured to output an input current in response to a sensing current output from at least one pixel; a sampling circuit configured to output a sampling voltage which is a reference voltage during a reset period, and which is a voltage varying based on the reference voltage and the input current during a signal period; and an accumulating circuit configured to generate an output voltage by accumulating variation values of the sampling voltage, and provide the generated output voltage to an analog-to-digital converter (ADC) circuit, wherein the sampling voltage decreases or increases from the reference voltage according to the input current during the signal period.

### CROSS-REFERENCE TO THE RELATED APPLICATION

This application claims priority from Korean Patent Application No. 10-2018-0095162, filed on Aug. 14, 2018, in the Korean Intellectual Property Office, the disclosure of which is incorporated herein in its entirety by reference.

### BACKGROUND

Apparatuses and methods consistent with the exemplary embodiments of the inventive concept relate to a display driving circuit for compensating for degradation in a display panel and an operating method of the display driving circuit.

Electronic devices, having an image display function, such as computers, tablet personal computers (PCs), and smartphones, may include a display system. The display system may include a display apparatus and a host processor, and the display apparatus may include a display panel and a display driving circuit.

The display panel may include a plurality of pixels and may be implemented as a flat panel display panel including an organic light-emitting diode (OLED). The display driving circuit may drive the display panel, based on image data. As the pixels are driven by data signals provided by the display driving circuit, the display panel may display an image. The display driving circuit may receive a control signal and the image data from a host processor. The host processor may periodically transmit the image data to the display driving circuit. The host processor and the display driving circuit may transmit and receive a signal through a high speed interface.

Luminance deviation may occur due to a characteristic deviation between switching elements (for example, transistors) included in the pixels, degradation in the switching elements, and degradation in a pixel diode (for example, an OLED). Therefore, a method of compensating for the luminance deviation is needed.

### SUMMARY

Exemplary embodiments of the inventive concept provide a display driving circuit for removing an error component of a current or a voltage needed for sensing in a process of continually sensing a degree of degradation in pixels to decrease luminance deviation of a display panel by compensating for the degradation in pixels, and an operating method of the display driving circuit.

According to an aspect of the inventive concept, there is provided a display driving circuit which may include: an input control circuit configured to output an input current in response to a sensing current output from at least one pixel; a sampling circuit configured to output a sampling voltage which is a reference voltage during a reset period, and which is a voltage varying based on the reference voltage and the input current during a signal period; and an accumulating circuit configured to generate an output voltage by accumulating variation values of the sampling voltage, and provide the generated output voltage to an analog-to-digital converter (ADC) circuit, wherein the sampling voltage decreases or increases from the reference voltage according to the input current during the signal period.

According to an aspect of the inventive concept, there is provided a display driving circuit which may include: a scan driver; a data driver; a sensing circuit configured to sense an input current from a display panel, comprising a plurality of pixels, through a monitor line; and a timing controller configured to control the scan driver and the data driver such that a first pixel among the pixels outputs a sensing current to the monitor line during a first compensation period, and a second pixel among the pixels outputs a compensation current, based on the input current, to the monitor line during a second compensation period.

According to an aspect of the inventive concept, there is provided an operating method of a display driving circuit controlling a display panel including a plurality of pixels. The operating method may include: controlling a first pixel among the pixels to output a sensing current during a first compensation period; sensing a first current flowing from a data pad, electrically connecting the display panel to the display driving circuit, to a sensing circuit included in the display driving circuit during the first compensation period; sensing a first leakage current generated in a current path in the sensing circuit during the first compensation period; controlling a second pixel among the pixels to output a compensation current corresponding to the first leakage current during the first compensation period; sensing a second current flowing from the data pad to the sensing circuit during a second compensation period, where the first pixel is turned off, after the first compensation period; and subtracting the second current from the first current to obtain a final sensing current.

### BRIEF DESCRIPTION OF THE DRAWINGS

Exemplary embodiments of the inventive concept will be more clearly understood from the following detailed description taken in conjunction with the accompanying drawings in which:

FIG. 1 is a block diagram of a display apparatus according to an exemplary embodiment;

FIG. 2 is a circuit diagram of a pixel according to an exemplary embodiment;

FIG. 3 is a diagram showing a current-voltage (IV) curve of a driving transistor according to an exemplary embodiment;

FIG. 4 is a block diagram of a monitoring circuit according to an exemplary embodiment;

FIG. 5 is a block diagram of a monitoring circuit according to an exemplary embodiment;

FIG. 6 is a waveform diagram of a voltage in a monitoring circuit according to an exemplary embodiment;

FIG. 7 is a sequence diagram of an operating method of a monitoring circuit according to an exemplary embodiment;

FIGS. 8A and 8B are circuit diagrams for describing a sensing circuit according to an exemplary embodiment;

FIG. 9 is a circuit diagram of a pixel according to an exemplary embodiment;

FIGS. 10A and 10B are circuit diagrams for describing a sensing circuit according to an exemplary embodiment;

FIGS. 11A and 11B are flowcharts of an operating method of a display driving circuit for compensating for a leakage current by using a sensing circuit, according to an exemplary embodiment; and

FIG. 12 is a block diagram of a display system according to an exemplary embodiment.

### DETAILED DESCRIPTION OF THE EMBODIMENTS

Hereinafter, embodiments will be described in detail with reference to the accompanying drawings. These embodiments all exemplary, and do not limit the inventive concept. An embodiment provided in the following description is not excluded from being associated with one or more features of another example or another embodiment also provided herein or not provided herein but consistent with the inventive concept. For example, even if matters described in a specific example or embodiment are not described in a different example or embodiment thereto, the matters may be understood as being related to or combined with the different example or embodiment, unless otherwise mentioned in descriptions thereof.

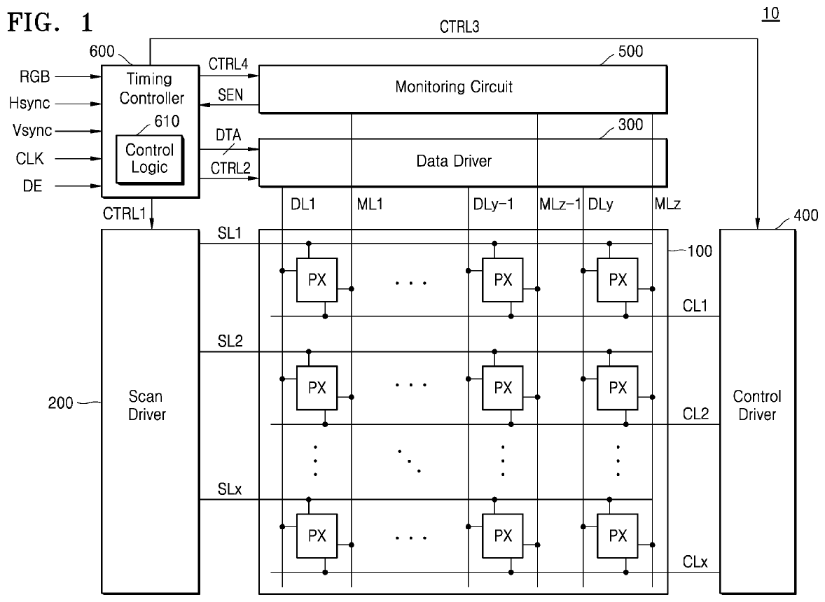

FIG. 1 is a block diagram of a display apparatus according to an exemplary embodiment.

Referring to FIG. 1, a display apparatus 10 may include an electronic device having an image display function. Examples of the electronic device may include smartphones, tablet personal computers (PCs), portable multimedia players (PMPs), cameras, wearable devices, televisions (TVs), digital video disk (DVD) players, refrigerators, air conditioners, air cleaners, set-top boxes, various medical apparatuses, navigation devices, global positioning system (GPS) receivers, vehicle apparatuses, furniture, various meters, etc.

Referring to FIG. 1, the display apparatus 10 may include a display panel 100, a scan driver 200, a data driver 300, a control driver 400, a monitoring circuit 500, and a timing controller 600.

The display panel 100 may include a plurality of pixels PX arranged in a matrix form to display an image by units of frames. The display panel 100 may be implemented as one of a light-emitting diode (LED) display, an organic LED (OLED) display, an active-matrix OLED (AMOLED) display, an electrochromic display (ECD), a digital mirror device (DMD), an actuated mirror device (AMD), a grating light valve (GLV), a plasma display panel (PDP), an electro luminescent display (ELD), a vacuum fluorescent display (VFD), and a liquid crystal display (LCD), but is not limited thereto. In other embodiments, the display panel 100 may be implemented as another kind of flat panel display or flexible display. For convenience of description, an OLED panel will be described as an example of the inventive concept.

The display panel 100 includes x (where x is an integer more than one) number of scan lines SL1 to SLx for transferring a scan signal in a row direction and y (where y is an integer more than one) number of data lines DL1 to DLy for transferring data signals in a column direction. In addition, the display panel 100 includes x number of control lines CL1 to CLx for transferring a control signal in the row direction and z (where z is an integer more than one) number of monitor lines ML1 to MLz for transferring pieces of data of the pixels PX to the monitoring circuit 500 in the column direction.

The display panel 100 may include the pixels PX which are provided at intersection points of the scan lines SL1 to SLx and the data lines DL1 to DLy and intersection points of the control lines CL1 to CLx and the monitor lines ML1 to MLz. For example, some pixels PX, which are connected to the same scan line, are adjacent to one another, and have different colors, of the plurality of pixels PX may configure a unit pixel, and in this case, each of the some pixels PX may be referred to as a subpixel.

During a horizontal driving period, pixels PX of one row may be driven, and during a next horizontal driving period, pixels PX of another row may be driven. For example, during a first horizontal driving period, pixels of a first horizontal line may be driven, and then, during a second horizontal driving period, pixels of a second horizontal line may be driven.

In response to a scan driver control signal CTRL1 provided from the timing controller 600, the scan driver 200 may provide a scan clock (or a gate-on signal) to the scan lines SL1 to SLx to select one scan line from among the scan lines SL1 to SLx. One scan line may be selected from among the scan lines SL1 to SLx according to the scan clock output from the scan driver 200, and thus, pixel signals (or image signals) respectively corresponding to pixels PX of one row corresponding to the selected scan line may be applied to the pixels of the one row through the data lines DL1 to DLy, thereby performing a display operation. In an embodiment, the scan lines SL1 to SLx may be sequentially or non-sequentially selected.

In response to a data driver control signal CTRL2, the data driver 300 may convert pieces of image data signal DTA into pixel signals (for example, grayscale voltages respectively corresponding to the plurality of pixels PX or currents respectively corresponding to the grayscale voltages) which are analog signals, and may respectively provide the pixel signals to the data lines DL1 to DLy, thereby driving the data lines DL1 to DLy. For example, the data driver 300 may charge the data lines DL1 to DLy, based on the pixel signals. During one horizontal driving period, the data driver 300 may provide the data lines DL1 to DLy with pixel signals corresponding to one row. Subsequently, when the scan clock is provided, the pixel signals may be provided, through the data lines DL1 to DLy, to pixels PX of a horizontal line corresponding to a scan line selected by the scan clock.

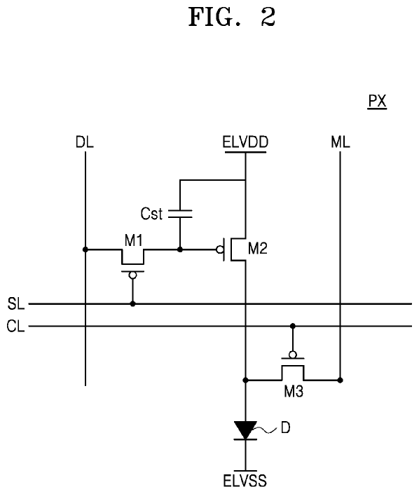

In response to a control driver control signal CTRL3, the control driver 400 may drive the control lines CL1 to CLx, for providing the monitoring circuit 500 with a signal representing a degradation state of each of the plurality of pixels PX. For example, the control driver 400 may apply a certain voltage to a control line connected to a gate electrode of a sensing transistor (for example, M3 of FIG. 2) included in each pixel PX to turn on the sensing transistor. As the sensing transistor is turned on, a current and/or a voltage for determining a degradation state of each pixel PX may be provided to the monitoring circuit 500 through a corresponding monitor line. For example, the current and/or the voltage may be a current and/or a voltage for determining a degradation state of a driving transistor (for example, M2 of FIG. 2) included in each pixel PX.

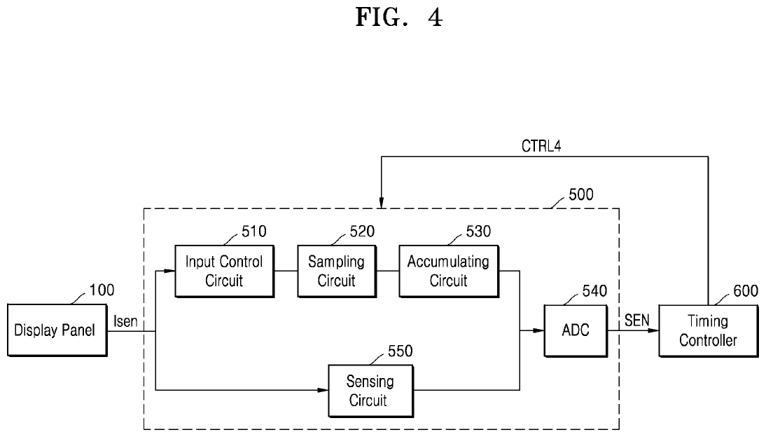

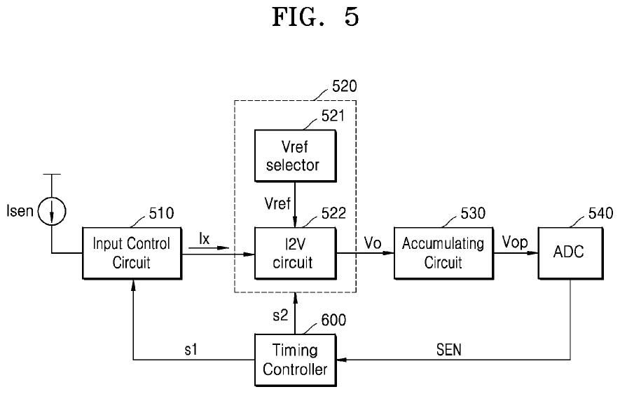

The monitoring circuit 500 may compensate for an error included in a voltage and/or a current which is applied from each pixel PX during a sensing period, thereby providing a sensing signal SEN to the timing controller 600. During the sensing period, the monitoring circuit 500 may be provided, through the monitor lines ML1 to MLz from the pixels PX, a voltage and/or a current (for example, Isen of FIGS. 4 and 5) representing a degree of degradation of the display panel 100.

The sensing signal SEN may be a signal which is obtained by the monitoring circuit 500 sensing an error component included in the voltage and/or the current representing a degree of degradation of the display panel 100. Based on the sensing signal SEN, the timing controller 600 may correct the image data signal DTA which are to be provided to the data driver 300, thereby uniformly compensating for luminance deviation in the display panel 100.

According to an embodiment, based on a corrected double sampling manner, the monitoring circuit 500 may convert a current (for example, Isen of FIGS. 4 and 5) output from each pixel PX into a voltage, and may extract the sensing signal SEN from which an error has been removed. In response to the sensing signal SEN corresponding to information which accurately includes a degradation state of each pixel PX because the error is removed, the timing controller 600 may control the display apparatus 10, and thus, may uniformly compensate for luminance deviation in the display panel 100. Accordingly, the monitoring circuit 500 may compensate for noise, offset, and the like to accurately determine a degree of degradation of each pixel PX.

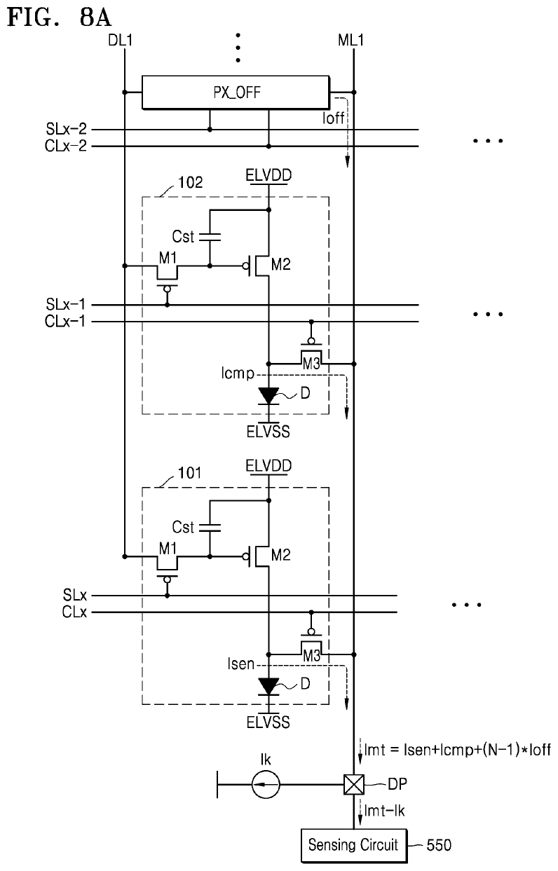

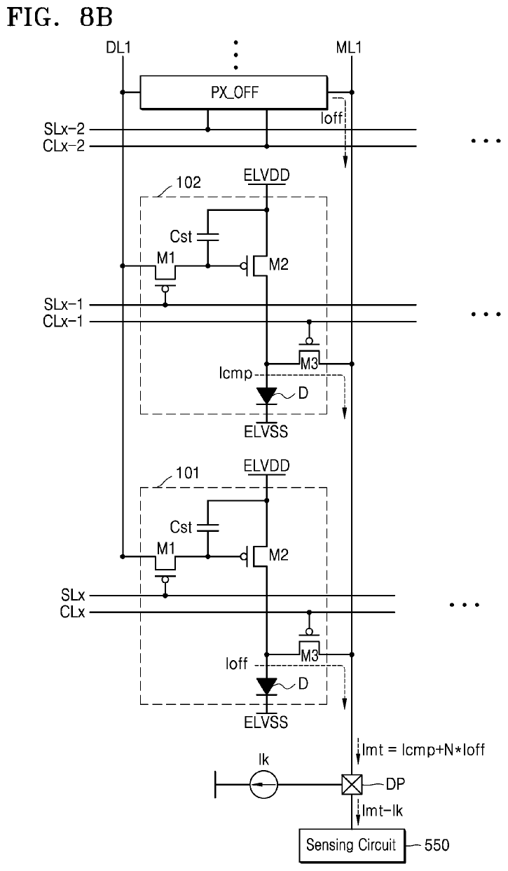

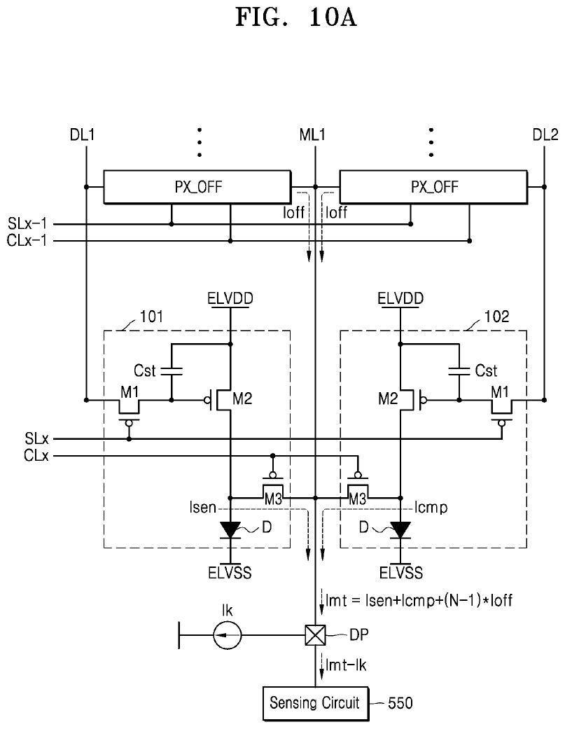

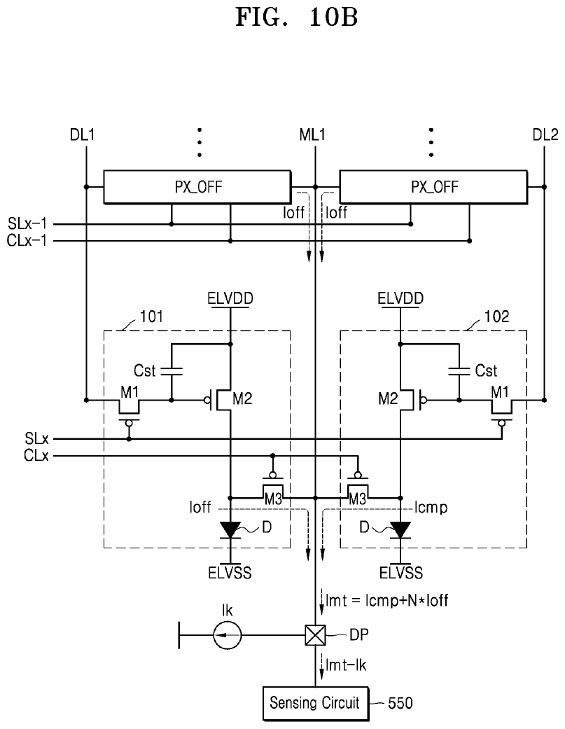

Further, the monitoring circuit 500 may compensate for an error component generated in a process where a monitoring current (for example, Imt of FIGS. 8A, 8B, 10A, and 10B) for determining a degree of degradation of each pixel PX is provided from the display panel 100 to the monitoring circuit 500 included in a display driving circuit. For example, the display panel 100 may be electrically connected, through a data pad, to elements of the display driving circuit including the scan driver 200, the data driver 300, the control driver 400, and the monitoring circuit 500. In this case, the data pad may be implemented as at least one data pad, for connecting the plurality of elements to the display panel 100. As the display panel 100 is connected to the display driving circuit through the data pad, a current path electrically connected from the data pad to the elements of the display driving circuit may be formed, and while a current is flowing through the current path, a leakage current may be generated. The monitoring circuit 500 may check the amount of the leakage current to control the pixels PX to provide a compensation current, thereby removing an influence of the leakage current which is input to the monitoring circuit 500 along with the monitoring current. The monitoring circuit 500 may provide the timing controller 600 with the sensing signal SEN from which the influence of the leakage current has been removed, and in response thereto, the timing controller 600 may control the display apparatus 10 to uniformly compensate for luminance deviation in the display panel 100.

The timing controller 600 may control an overall operation of the display apparatus 10, and may include a control logic 610. For example, the timing controller 600 may receive pieces of image data RGB and timing signals (for example, a horizontal synchronization signal Hsyn, a vertical synchronization signal Vsyn, a clock signal CLK, and a data enable signal DE) from an external apparatus (for example, a host apparatus), and may generate the scan driver control signal CTRL1, the data driver control signal CTRL2, and the control driver control signal CTRL3 for respectively controlling the scan driver 200, the data driver 300, and the control driver 400, based on the received image data RGB and timing signals. Also, the timing controller 600 may generate a monitoring circuit control signal CTRL4 which controls the monitoring circuit 500 to generate the sensing signal SEN during the sensing period. The timing controller 600 may convert a format of the image data RGB received from the outside into a format suitable for an interface specification corresponding to the data driver 300, and may transfer converted image data signal DTA to the data driver 300. For example, the converted image data signal DTA may include packet data.

The timing controller 600 may include the control logic 610. In response to the sensing signal SEN, the control logic 610 may determine a degradation state of each of the plurality of pixels PX, correct the image data signal DTA according to the determined degradation state, and provide the corrected image data signal DTA to the data driver 300. For example, the control logic 610 may generate an image data signal DTA which is corrected based on information about a degradation state (for example, a degradation state of each of mobility, a threshold voltage, etc.), included in the sensing signal SEN, of the driving transistor (for example, M2 of FIG. 2) of each pixel PX. As another example, the control logic 610 may generate an image data signal DTA which is corrected based on information about a degradation state, included in the sensing signal SEN, of an LED (for example, D of FIG. 2) of each pixel PX.

In FIG. 1, the control logic 610 is illustrated as being included in the timing controller 600, but is not limited thereto. In other embodiments, the control logic 610 may be a separate circuit independent of the timing controller 600. In this case, the control logic 610 may receive the image data signal DTA from the timing controller 600 to generate new image data corrected based on a degradation state, and may provide signals corresponding to the generated image data to the display panel 100 through the data lines DL1 to DLy. In an embodiment, the control logic 610 may be included in the data driver 300.

Although not shown, the display apparatus 10 may further include a voltage generator and an interface. The voltage generator may generate various voltages applied to the display panel 100 and the display driving circuit.

The interface may communicate with an external apparatus (for example, a host processor) and may receive the image data RGB and the timing signals from the external apparatus. For example, the interface may include one of an RGB interface, a central processing unit (CPU) interface, a serial interface, a mobile display digital interface (MDDI), an inter integrated circuit (I2C) interface, a serial peripheral interface (SPI), a micro controller unit (MCU) interface, a mobile industry processor interface (MIPI), an embedded display port (eDP), a D-subminiature (D-sub) interface, an optical interface, and a high definition multimedia interface (HDMI). In addition, the interface may include one of various serial or parallel interfaces.

In the present embodiment, the scan driver 200, the data driver 300, the control driver 400, the monitoring circuit 500, and the timing controller 600 are illustrated as different function blocks. In an embodiment, the elements may be implemented as different semiconductor chips, and at least two elements may be implemented as one semiconductor chip. For example, the data driver 300 and the timing controller 600 may be integrated into one semiconductor chip. Also, some elements may be integrated into the display panel 100. For example, the scan driver 200 may be integrated into the display panel 100.

FIG. 2 is a circuit diagram of a pixel according to an exemplary embodiment.

Referring to FIG. 2, a pixel PX may include a switching transistor M1, a driving transistor M2, a sensing transistor M3, a capacitor Cst, and a diode D.

A first electrode of the switching transistor M1 may be connected to a data line DL, a second electrode thereof may be connected to the driving transistor M2, and a gate electrode thereof may be connected to a scan line SL. When the switching transistor M1 is turned on in response to a scan signal provided through the scan line SL, the switching transistor M1 may transfer a data signal to the driving transistor M2. For example, the data signal may be an analog signal, namely, a certain grayscale voltage corresponding to digital data.

The driving transistor M2 may include a first electrode connected to a driving voltage ELVDD, a second electrode connected to an anode electrode of the diode D, and a gate electrode connected to the switching transistor M1 and the capacitor Cst. The driving transistor M2 may control the amount of current flowing in the diode D with a voltage of the capacitor Cst based on the driving voltage ELVDD.

The capacitor Cst may include a first electrode connected to the driving voltage ELVDD and a second electrode connected to the switching transistor M1 and the driving transistor M2. The capacitor Cst may store an electric charge corresponding to a voltage difference between the driving voltage ELVDD and the data signal.

The diode D may include the anode electrode connected to the driving transistor M2 and the sensing transistor M3, a cathode electrode connected to a ground voltage ELVSS, and a plurality of light emitting layers which emit light with a current flowing therein. The current may flow to the cathode electrode through the anode electrode, and at this time, the light emitting layers may emit the light with the flowing current. The diode D may be, for example, an OLED.

The current flowing to the diode D via the driving transistor M2 may be determined based on a threshold voltage “Vth” of the driving transistor M2 and a mobility “μ” of the driving transistor M2. For example, the current may be represented as in following Equation (1):

I=W*μ*Ci*(Vgs−Vth)²/(2L) (1)

where Equation (1) represents a numerical value corresponding to the driving transistor M2, W denotes a gate channel width, Ci denotes a gate insulating layer capacity, Vgs denotes a gate-source voltage, and L denotes a gate channel length.

The sensing transistor M3 may include a first electrode connected to the driving transistor M2 and the anode electrode of the diode D, a second electrode connected to a monitor line ML, and a gate electrode connected to a control line CL. When the sensing transistor M3 is turned on in response to a signal provided through the control line CL, the sensing transistor M3 may provide the monitor line ML with a current provided from the driving transistor M2. According to embodiments, the first electrode of the sensing transistor M3 may be connected to the cathode electrode of the diode D. In this case, when the sensing transistor M3 is turned on, the current provided from the driving transistor M2 and the diode D may be provided to the monitor line ML. Hereinafter, a time period where the sensing transistor M3 is turned on and the current is provided to the monitor line ML may be referred to as a sensing period.

According to an embodiment, in the sensing period, the display driving circuit may obtain degradation information about the driving transistor M2 and/or the diode D, based on a value of a current which is output through the monitor line ML from the pixel PX. In this case, the value of the current output through the monitor line ML may include an error component corresponding to at least one of noise, an offset, and a leakage current caused by a circuit. The monitoring circuit 500 may provide the timing controller 600 with the sensing signal SEN of which such error component has been compensated for. Accordingly, the timing controller 600 may obtain accurate degradation information about the pixel PX, based on the monitoring circuit 500.

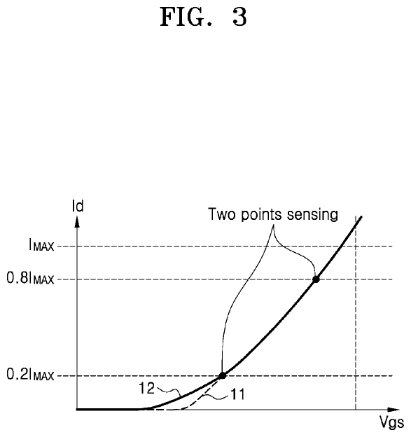

FIG. 3 is a diagram showing a current-voltage (IV) curve of a driving transistor according to an exemplary embodiment. Referring to the graph of FIG. 3, the abscissa axis represents a gate-source voltage Vgs of the driving transistor M2, and the ordinate axis represents a driving current Id passing through a source-drain electrode of the driving transistor M2.

A characteristic of the driving transistor M2 may be degraded when the display panel 100 is driven for a long time. For example, a threshold voltage may be reduced, and mobility may be reduced. In this case, a characteristic of a current I1 before the driving transistor M2 is degraded may differ from a characteristic of a current I2 after the driving transistor M2 is degraded. For example, a current slope may vary, and a current curve may be shifted to the left and the right.

The driving transistor M2 may be continuously degraded, and thus, the display driving circuit may periodically check a degradation state. For example, the display driving circuit may compensate for a level of the driving current Id in response to a variation value of each of points (for example, 0.8×Imax, and 0.2×Imax) corresponding to a certain ratio of a maximum value Imax of a driving current checked at every predetermined period.

In this case, the data driver 300 may control a voltage applied to the data line DL to apply the sensing current Isen to the driving transistor M2. That is, a driving current amount (for example, 0.8×Imax, and 0.2×Imax) may be the sensing current Isen. Various characteristics of the driving transistor M2 as in Equation (1) may be reflected in a value of the sensing current Isen passing through the driving transistor M2. Therefore, the data driver 300 may determine a degradation state of the driving transistor M2 by using the value of the sensing current Isen. Hereinafter, various embodiments for removing an error included in the sensing current Isen will be described with reference to the drawings.

FIG. 4 is a block diagram of a monitoring circuit according to an exemplary embodiment.

Referring to FIG. 4, a monitoring circuit 500 may include an input control circuit 510, a sampling circuit 520, an accumulating circuit 530, an analog-to-digital converter (ADC) 540, and a sensing circuit 550. The monitoring circuit 500 may receive a sensing current Isen from a display panel 100 to provide a sensing signal SEN to a timing controller 600. The timing controller 600 may provide the monitoring circuit 500 with a monitoring circuit control circuit CTRL4 so as to remove an error of the sensing current Isen during a sensing period.

The input control circuit 510, the sampling circuit 520, the accumulating circuit 530, and the ADC 540 according to an embodiment may generate the sensing signal SEN obtained by removing error components such as noise and/or an offset from the sensing current Isen, based on the correlated double sampling manner. This will be described below with reference to FIGS. 5 to 7.

The sensing circuit 550 and the ADC 540 according to an embodiment may compensate for a leakage current (for example, Ik of FIGS. 8A, 8B, 10A, and 10B) which occurs in a process where the sensing current Isen is applied from the display panel 100 to the display driving circuit. This will be described below with reference to FIGS. 8A to 11B.

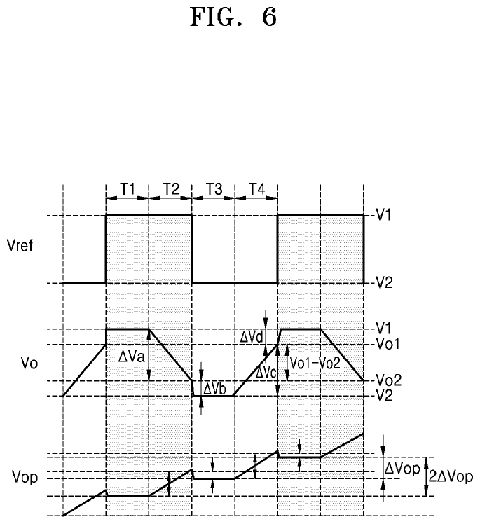

FIG. 5 is a block diagram of a monitoring circuit according to an exemplary embodiment, and FIG. 6 is a waveform diagram of a voltage in a monitoring circuit according to an exemplary embodiment.

Referring to FIG. 5, a monitoring circuit 500 according to an embodiment may include an input control circuit 510, a sampling circuit 520, an accumulating circuit 530, and an ADC 540, and the sampling circuit 520 may include a reference voltage selector 521 and a current-to-voltage (I2V) circuit 522.

The input control circuit 510 may receive a sensing current Isen from the display panel 100 to provide an input current Ix to the sampling circuit 520. The input control circuit 510 may control the input current Ix, based on a control signal s1 provided from the timing controller 600. For example, the timing controller 600 may differently control the input current Ix over time. Here, the control signal s1 may be included in the monitoring circuit control signal CTRL4.

For example, the input control circuit 510 may provide the input current Ix in a forward direction which is the same direction as the sensing current Isen. In this case, the forward direction may be referred to as a direction of a current flowing from the input control circuit 510 to the sampling circuit 520. That is, like a conducting wire, equivalent modeling may be performed on the input control circuit 510. In this case, the input control circuit 510 may be set to a forward direction pass mode.

In addition, the input control circuit 510 may provide the input current Ix in a reverse direction opposite to the sensing current Isen. That is, the input control circuit 510 may receive the sensing current Isen to generate a reverse-direction current provided from the sampling circuit 520 to the input control circuit 510. In this case, the input control circuit 510 may be set to a reverse direction pass mode.

According to embodiments, the input control circuit 510 may include a current mirror including a pair of transistors (for example, first and second transistors). The sensing current Isen may be applied to the first transistor of the current mirror, and the second transistor of the current mirror may output the input current Ix obtained by controlling a level and a direction of the sensing current Isen. The current mirror may be implemented as various types known to one of ordinary skill in the art, and its detailed description is omitted. Alternatively, the input control circuit 510 may be expressed as a controlled current source capable of being equivalently modeled as a current controlled current source. In this case, an input variable of the controlled current source may be the sensing current Isen, the controlled current source may have an arbitrary control variable, and an output variable of the controlled current source may be the input current Ix.

The sampling circuit 520 may generate a sampling voltage Vo, based on a reference voltage Vref and the input current Ix. The reference voltage selector 521 may periodically generate a first voltage V1 and a second voltage V2 as the reference voltage Vref, and the I2V circuit 522 may generate the sampling voltage Vo by adding the reference voltage Vref to a voltage increment (or increase) or a voltage decrement (or decrease) based on the input current Ix. Each of the first voltage V1 and the second voltage V2 may individually have an arbitrary value. For example, the first voltage V1 may be a logic high voltage, and the second voltage V2 may be a logic low voltage. On the other hand, the first voltage V1 may be a logic low voltage, and the second voltage V2 may be a logic high voltage. Meanwhile, the first voltage V1 and the second voltage V2 may have the same level. Hereinafter, for convenience of description, an example where the first voltage V1 is a logic high voltage and the second voltage V2 is a logic low voltage will be described.

According to an embodiment, the reference voltage selector 521 may include a switching element which is controlled according to a control signal s2 provided from the timing controller 600. The reference voltage selector 521 may periodically provide the I2V circuit 522 with a logic high voltage V1 and a logic low voltage V2, based on an operation of the switching element. For example, the switching element may be implemented as a multiplexer MUX which receives the logic high voltage V1 and the logic low voltage V2 to output the reference voltage Vref, but is not limited thereto. The control signal s2 may be included in the monitoring circuit control signal CTRL4.

According to an embodiment, the I2V circuit 522 may include an operational amplifier circuit. In this case, the reference voltage Vref may be applied to a non-inverting input terminal of the I2V circuit 522, and an inverting input terminal of the I2V circuit 522 may be connected to an output terminal thereof through feedback. The input current Ix may be input to the inverting input terminal side, and may be applied to a feedback branch. Similarly to an integrating circuit using an operational amplifier, the feedback branch may include a capacitor. A voltage of the inverting input terminal may have a value of the reference voltage Vref, based on a virtual ground. A voltage of the capacitor of the feedback branch may have a voltage decrement, based on a forward-direction input current Ix. Therefore, when the forward-direction input current Ix is applied to the I2V circuit 522, the sampling voltage Vo of the output terminal may have a value obtained by adding the reference voltage Vref based on the virtual ground to a voltage decrement based on the input current Ix. On the other hand, the voltage of the capacitor of the feedback branch may have a voltage increment based on a reverse-direction input current Ix. Therefore, when the reverse-direction input current Ix is applied to the I2V circuit 522, the sampling voltage Vo of the output terminal may have a value obtained by adding the reference voltage Vref based on the virtual ground to a voltage increment based on the input current Ix. A conducting wire may be connected to the capacitor of the feedback branch in parallel, and may include a serially connected switch. In a time period where the I2V circuit 522 is set to a below-described high reset mode or low reset mode, the switch may be turned on based on the control signal s2, and may be equivalently modeled as the conducting wire connected to the capacitor in parallel.

However, the inventive concept is not limited to an example where the I2V circuit 522 is implemented with the operational amplifier circuit, and may be applied to all circuits for generating a signal which is the same as or similar to a waveform diagram of FIG. 6.

According to another embodiment, the I2V circuit 522 may output the reference voltage Vref as the sampling voltage Vo. That is, the I2V circuit 522 may output the reference voltage Vref as the sampling voltage Vo regardless of the input current Ix, and may provide the sampling voltage Vo to the accumulating circuit 530.

Hereinafter, the sampling voltage Vo output from the sampling circuit 520 will be described based on time periods with reference to FIGS. 5 and 6.

Referring to FIG. 6, the abscissa axis represents time, and the ordinate axis represents levels of the reference voltage Vref, the sampling voltage Vo, and the output voltage Vop. In a second period T2 and a fourth period T4, the sampling circuit 520 may output the sampling voltage Vo having the above-described voltage increment and voltage decrement, and in a first period T1 and a third period T3, the sampling circuit 520 may output the sampling voltage Vo corresponding to the reference voltage Vref. Each of the first period T1 and the third period T3 may be a reset period, and each of the second period T2 and the fourth period T4 may be a signal period.

In the first period T1, the input control circuit 510 may operate in the forward direction pass mode, and the sampling circuit 520 may output the reference voltage Vref as the sampling voltage Vo. In this case, the reference voltage selector 521 may apply the logic high voltage V1 to the I2V circuit 522. Also, the I2V circuit 522 may be set to a high reset mode.

In the second period T2, the input control circuit 510 may operate in the forward direction pass mode, and the sampling circuit 520 may output the sampling voltage Vo obtained by adding the reference voltage Vref to the voltage decrement based on the forward-direction input current Ix. The sampling voltage Vo may be shifted from the logic high voltage V1 to a second sampling voltage Vo2. In this case, the reference voltage selector 521 may apply the logic high voltage V1 to the I2V circuit 522, and the I2V circuit 522 may be set to a first signal mode.

In the third period T3, the input control circuit 510 may operate in the forward direction pass mode, and the sampling circuit 520 may output the reference voltage Vref as the sampling voltage Vo. In this case, unlike the first period T1, the reference voltage selector 521 may apply the logic low voltage V2 to the I2V circuit 522. Also, the I2V circuit 522 may be set to a low reset mode.

In the fourth period T4, the input control circuit 510 may operate in the reverse direction pass mode, and the sampling circuit 520 may output the sampling voltage Vo obtained by adding the reference voltage Vref to the voltage increment based on the reverse-direction input current Ix. The sampling voltage Vo may be shifted from the logic low voltage V2 to a first sampling voltage Vo1. In this case, the reference voltage selector 521 may apply the logic low voltage V2 to the I2V circuit 522, and the I2V circuit 522 may be set to a second signal mode.

The sampling circuit 520 may output the sampling voltage Vo including a signal component “Vo1-Vo2” based on a voltage increment and a voltage decrement during one period.

Referring to FIG. 5, the accumulating circuit 530 may accumulate the sampling voltage Vo applied thereto to generate the output voltage Vop. The accumulating circuit 530 may generate the output voltage Vop by accumulating and summating levels by which the sampling voltage Vo varies. The accumulating circuit 530 may be implemented with at least one of various integrating circuits know to one of ordinary skill in the art.

Referring to FIG. 6, the output voltage Vop may include a voltage “ΔVop” corresponding to a signal component during one period. The voltage “ΔVop” corresponding to the signal component may be a value based on the first sampling voltage Vo1 and the second sampling voltage Vo2 which are signal components included in the sampling voltage Vo, and may be a voltage obtained by removing the logic high voltage V1 and the logic low voltage V2 of the reference voltage Vref corresponding to offset components. The voltage “A Vop” corresponding to the signal component may be represented as in following Equation (2):

$$2 * Δ Vop = Aint * ( Δ Va + Δ Vb + Δ Vc + Δ Vd ) = Aint * [ ( V 1 - Vo 2 ) - ( Vo 2 - V 2 ) + ( Vo 1 - V 2 ) - ( V 1 - Vo 1 ) ] = Aint * ( - Vo 2 - Vo 2 + Vo 1 + Vo 1 ) = 2 * Aint * ( Vo 1 - Vo 2 ) \\ Δ Vop = Aint * ( Vo 1 - Vo 2 ) \qquad ( 2 )$$

where Aint denotes a gain of the accumulating circuit 530, and ΔVa to ΔVd denote variations of the sampling voltage Vo as in FIG. 6.

The accumulating circuit 530 may provide the ADC 540 with the output voltage Vop including the voltage “ΔVop” corresponding to the signal component, and the ADC 540 may provide the timing controller 600 with the sensing signal SEN obtained by digitizing the output voltage Vop. Therefore, the control logic 610 may correct the image data signal DTA according to a degradation state of the display panel 100, based on the sensing signal SEN, and may provide the corrected image data signal DTA to the data driver 300.

As in Equation (2), the monitoring circuit 500 may remove an offset voltage component (for example, the logic high voltage V1 and the logic low voltage V2), and may provide the output voltage Vop including a signal component (for example, Vo1-Vo2) to the timing controller 600 via the ADC 540.

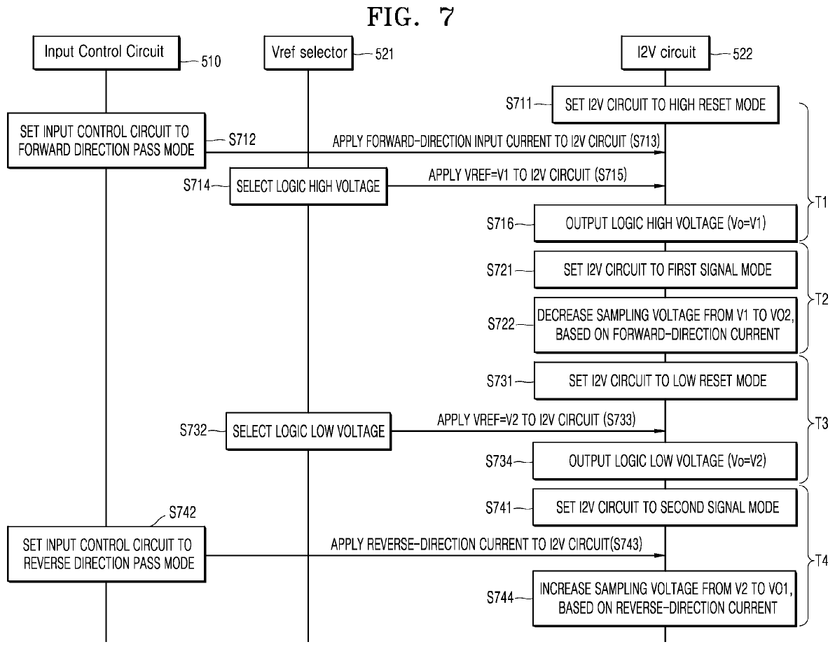

FIG. 7 is a sequence diagram of an operating method of a monitoring circuit according to an exemplary embodiment.

According to an embodiment, in operation S712, the input control circuit 510 may be set to the forward direction pass mode in the first period T1. For example, the input control circuit 510 may be set to the forward direction pass mode in response to the monitoring circuit control signal CTRL4 received from the timing controller 600. In operation S713, the input control circuit 510 may apply the forward-direction input current Ix to the I2V circuit 522. For example, the forward-direction input current Ix may have a level obtained by multiplying the sensing current Isen by a gain value including one (1).

The reference voltage selector 521 may select the logic high voltage V1 as the reference voltage Vref in operation S714, and may apply the logic high voltage V1 to the I2V circuit 522.

In this case, the I2V circuit 522 may be set to the high reset mode in operation S711, and thus, may output the logic high voltage V1 as the sampling voltage Vo in operation S716. Unlike the illustration, operation S711 may be performed after operation S715.

According to an embodiment, in the second period T2, the I2V circuit 522 may be set to the first signal mode in operation S721. Subsequently, in operation S722, the I2V circuit 522 may output the sampling voltage Vo including a voltage decrement caused by the forward-direction input current Ix, based on the logic high voltage V1 applied from the reference voltage selector 521. In this case, the sampling voltage Vo may decrease to the second sampling voltage Vo2.

According to an embodiment, in the third period T3, the I2V circuit 522 may be set to the low reset mode in operation S731. The reference voltage selector 521 may select the logic low voltage V2 as the reference voltage Vref in operation S732, and may apply the logic low voltage V2 to the I2V circuit 522. In operation S734, the I2V circuit 522 may output the logic low voltage V2 as the sampling voltage Vo in response to the logic low voltage V2 applied thereto. Unlike the illustration of FIG. 7, operation S731 may be performed after operation S733.

According to an embodiment, in the fourth period T4, the I2V circuit 522 may be set to the second signal mode in operation S741. The input control circuit 510 may be set to the reverse direction pass mode in operation S742. For example, the input control circuit 510 may be set to the reverse direction pass mode in response to the monitoring circuit control signal CTRL4 received from the timing controller 600. The input control circuit 510 may apply the reverse-direction input current Ix to the I2V circuit 522 in operation S743. For example, the reverse-direction input current Ix may be obtained by multiplying the sensing current Isen by a negative gain value including −1. Unlike the illustration, operation S741 may be performed after operation S743. Subsequently, in operation S744, the I2V circuit 522 may output the sampling voltage Vo including a voltage increment caused by the reverse-direction input current Ix, based on the logic low voltage V2 applied from the reference voltage selector 521. In this case, the sampling voltage Vo may increase to the first sampling voltage Vo1.

According to an embodiment, error components such as an offset and noise occurring in a process of sensing the sensing current Isen input from the pixel PX may be removed, and then, the sensing current Isen may be provided to the timing controller 600. Hereinafter, a method of compensating for a leakage current caused by an electrical connection between the display panel 100 and the display driving circuit will be described.

FIGS. 8A and 8B are circuit diagrams for describing a sensing circuit according to an exemplary embodiment.

Referring to FIGS. 8A and 8B, the display panel 100 of FIG. 1 may include a first pixel 101, a second pixel 102, and a plurality of off pixels PX_OFF, and may be connected to a first monitor line ML1. In each of the plurality of off pixels PX_OFF, a first leakage current Ioff may be provided (leaked) to the first monitor line ML1. An off pixel PX_OFF may denote a pixel PX where a driving transistor M2 is turned off based on control by the timing controller 600, or a diode D is turned off, and thus, a current does not flow to a node having a ground voltage ELVSS.

The display panel 100 may be electrically connected to a sensing circuit 550 through a data pad DP. A second leakage current Ik may occur in a current path electrically connected from the data pad to elements, other than the sensing circuit 550, of the display driving circuit.

Referring to FIGS. 8A and 8B, the sensing circuit 550 may obtain an accurate sensing current Isen by removing a first leakage current loff generated in the display panel 100 and the second leakage current Ik generated in the display driving circuit, thereby providing an accurate sensing signal SEN to the timing controller 600.

According to an embodiment, the sensing circuit 550 may include at least one of the sampling circuit 520 and the accumulating circuit 530 described above with reference to FIGS. 1 to 7. That is, the sensing circuit 550 may obtain the sensing current Isen by using the sampling circuit 520 and the accumulating circuit 530 to provide the sensing signal SEN to the timing controller 600.

In FIGS. 8A and 8B, the same circuit is illustrated. A first compensation period is illustrated in FIG. 8A, and a second compensation period is illustrated in FIG. 8B.

Referring to FIG. 8A, during the first compensation period, the timing controller 600 may control the display driving circuit to obtain degradation information about the driving transistor M2 of a first pixel 101. The timing controller 600 may control the data driver 300 to control the first pixel 101 to output the sensing current Isen, and also control the data driver 300 to control the second pixel 102 to output a compensation current Icmp. The compensation current Icmp, as described below, may be a current for compensating for the second leakage current Ik. In this case, the data driver 300 may apply a voltage corresponding to a corresponding current to a first data line DL1. The timing controller 600 may control the scan driver 200 to turn off a switching transistor M1 of each of the plurality of off pixels PX_OFF.

Referring to FIG. 8B, during the second compensation period, the timing controller 600 may control the scan driver 200 to turn off the first pixel 101. For example, the timing controller 600 may control the driving transistor M2 through the switching transistor M1 to turn off the first pixel 101. Therefore, the timing controller 600 may control the display driving circuit to output a monitoring current Imt which includes the compensation current Icmp and the first leakage current Ioff except the sensing current Isen. Description overlapping the first compensation period of FIG. 8A is omitted.

According to an embodiment, the sensing circuit 550 may provide the ADC 540 with the sensing current Isen from which the first leakage current Ioff has been removed. In detail, during the first compensation period, the sensing circuit 550 may summate the sensing current Isen, the compensation current Icmp, and N−1 times the first leakage current Ioff, and may subtract the second leakage current Ik from a summated value to obtain a current (for example, Isen+Icmp+(N−1)×Ioff−Ik). Here, N−1 may denote the number of off pixels in the first compensation period. During the second compensation period, the sensing circuit 550 may summate the compensation current Icmp and N times the first leakage current Ioff, and may subtract the second leakage current Ik from a summated value to obtain a current (for example, Icmp+N×Ioff−Ik). Here, N may denote the number of off pixels in the second compensation period.

The sensing circuit 550 may subtract the amount of current, obtained in the second compensation period, from the amount of current obtained in the first compensation period. For example, the sensing circuit 550 may obtain a subtracted current as in following Equation (3). In Equation (3), I1 may denote a current obtained by the sensing circuit 550 in the first compensation period, and I2 may denote a current obtained by the sensing circuit 550 in the second compensation period.

I1−I2={Isen+Icmp+(N−1)×Ioff−Ik}−(Icmp+N×Ioff−Ik) (3)

where N−1 may denote the number of off pixels in the first compensation period, N may denote the number of off pixels in the second compensation period, and the number of pixels included in the display panel 100 may have a large value, whereby the sensing circuit 550 may obtain the sensing current Isen. Therefore, the sensing circuit 550 may obtain the sensing current Isen from which the first leakage current Ioff has been removed.

According to an embodiment, the sensing circuit 550 may receive a current, from which the second leakage current Ik has been removed, from the data pad DP. When the second leakage current Ik is generated in the display driving circuit, a level of the sensing current Isen may be limited. For example, when a level of the sensing current Isen is 0.3 A and a total sum of leakage currents Ioff is 0.1 A, a current applied from the display panel 100 to the data pad DP may be 0.4 A. However, when a level of the second leakage current Ik which is generated in the display driving circuit and is received from the data pad DP is 0.5 A, the sensing circuit 550 may not receive a current from the data pad DP. Accordingly, the timing controller 600 may control the second pixel 102 to provide the compensation current Icmp having a value which is equal to or greater than the second leakage current Ik.

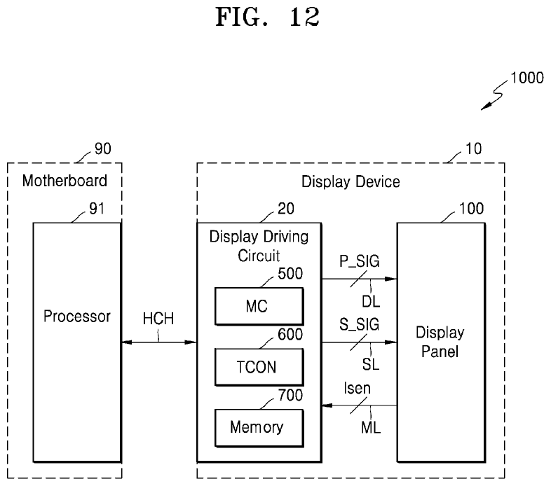

According to an embodiment, the timing controller 600 may control the second pixel 102 to output the compensation current Icmp based on a value pre-stored in a memory (for example, a memory 700 of FIG. 12). For example, the pre-stored value may be a value which corresponds to the second leakage current Ik, which is generated in the display driving circuit and is received from the data pad DP, and is obtained by applying a test current through the data pad DP in a process stage.

According to an embodiment, the timing controller 600 may sense the second leakage current Ik, and may control the second pixel 102 to output the compensation current Icmp. For example, the timing controller 600 may turn off all pixels PX. In this case, when a diode through which only a current flowing in one direction passes is connected between the data pad DP and the sensing circuit 550, the timing controller 600 may not receive any current due to an influence of the second leakage current Ik. Subsequently, when the timing controller 600 controls the display driving circuit to control the second pixel 102 to output the compensation current Icmp having a slope having a positive value, the sensing circuit 550 may receive the current flowing in the one direction at a certain time. That is, referring to FIG. 8B, the timing controller 600 may identify, as the second leakage current Ik, the compensation current Icmp output from the second pixel 102 at a time (for example, a time when Imt>Ik is satisfied) when a current “Imt-Ik” flowing from the data pad DP to the sensing circuit 550 becomes a positive value.

Referring to FIG. 8B, when the timing controller 600 controls the second pixel 102 to output the compensation current Icmp having the same level as that of the second leakage current Ik, the sensing circuit 550 may identify a current, received through the data pad DP, as a total sum of first leakage currents Ioff output from the plurality of off pixels PX_OFF.

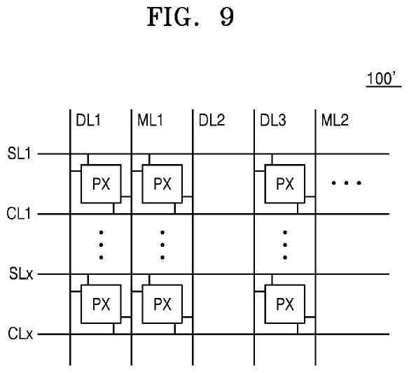

FIG. 9 is a circuit diagram of a pixel according to an exemplary embodiment.

Referring to FIG. 9, a display apparatus 100′ may include a plurality of pixels PX. According to an embodiment, pixels PX connected to different data lines DL may share one monitor line ML. For example, a pixel PX connected to a first data line DL1 and a pixel PX connected to a second data line DL2 among a plurality of pixels PX arranged in a first row may be connected to a first monitor line ML1. Herein, descriptions of FIGS. 10A and 10B will be given with reference to the display apparatus 100′ of FIG. 9.

FIGS. 10A and 10B are circuit diagrams for describing a sensing circuit according to an exemplary embodiment.

Referring to FIG. 10A, during a first compensation period, the timing controller 600 may control the display driving circuit so that a first pixel 101 outputs a sensing current Isen and a second pixel 102 outputs a compensation current Icmp.

Referring to FIG. 10B, during a second compensation period, the timing controller 600 may control the display driving circuit such that the second pixel 102 outputs the compensation current Icmp, and the first pixel 101 and a plurality of off pixels PX_OFF are turned off.

The sensing circuit 550 may subtract a current, obtained in the second compensation period, from a current obtained in the first compensation period to obtain the sensing current Isen from which a first leakage current Ioff has been removed. The sensing circuit 550 may receive a current, from which the second leakage current Ik has been removed, from a data pad DP. According to an embodiment, the timing controller 600 may control the second pixel 102 to output the compensation current Icmp corresponding to a level of the second leakage current Ik. According to another embodiment, the timing controller 600 may sense the second leakage current Ik, and may control the second pixel 102 to output the compensation current Icmp corresponding to a level of the sensed second leakage current Ik. A detailed description overlapping the above-described drawing is omitted.

The signal lines (the first data line DL1, the first monitor line ML1, the plurality of scan lines, and the plurality of control lines) illustrated in FIGS. 8A, 8B, 10A, and 10B are illustrated for convenience of description, and the order of the signal lines may be variously applied. For example, the order of the signal lines may be applied to the second data line DL2, the third monitor line ML3, etc.

Moreover, positions of the first pixel 101, the second pixel 102, and the off pixels PX_OFF are not limited. For example, in FIGS. 8A and 8B, the first pixel 101 and the second pixel 102 are illustrated in adjacent rows, but are not limited thereto. In FIGS. 10A and 10B, the first pixel 101 and the second pixel 102 are illustrated in the same row, but are not limited thereto.

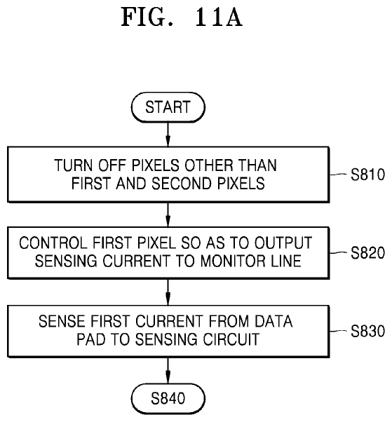

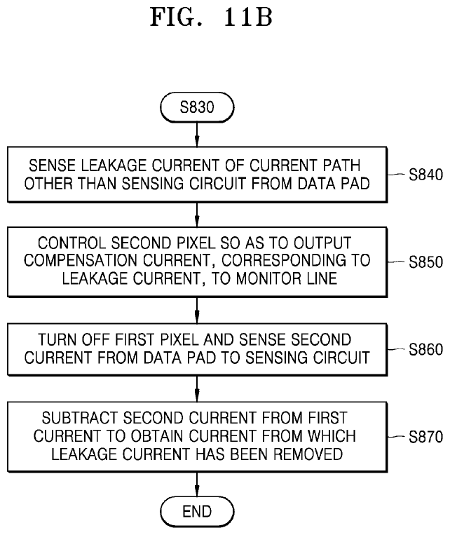

FIGS. 11A and 11B are flowcharts of an operating method of a display driving circuit for compensating for a leakage current by using a sensing circuit, according to an exemplary embodiment.

Referring to FIG. 11A, in operation S810, the timing controller 600 may turn off pixels other than the first and second pixels 101 and 102 during the first compensation period. Subsequently, in operation S820, the timing controller 600 may control the first pixel 101 to output the sensing current Isen to the monitor line ML. In operation S830, the sensing circuit 550 may sense a first current received via the data pad DP. In this case, the first current may be a current having a level “Isen+Icmp+(N−1)×Ioff−Ik”.

Subsequently, referring to FIG. 11B, the sensing circuit 550 may sense the second leakage current Ik occurring in a current path electrically connected from the data pad DP to each of elements, other than the sensing circuit 550, of the display driving circuit in operation S840. In operation S850, the timing controller 600 may control the second pixel 102 to output the compensation current Icmp, corresponding to the sensed second leakage current Ik, to the monitor line ML.

During the second compensation period, the timing controller 600 may turn off the first pixel 101, and may sense a second current received by the sensing circuit 550 from the data pad DP in operation S860. In this case, the second current may be a current having a level “Icmp+N×Ioff−Ik”.

Subsequently, in operation S870, the sensing circuit 550 may subtract the second current, obtained in the second compensation period, from the first current obtained in the first compensation period to obtain the sensing current Isen from which the first leakage current Ioff has been removed. The sensing circuit 550 may transfer the obtained sensing current Isen to the ADC 540, the ADC 540 may transfer the sensing signal SEN to the timing controller 600, and the timing controller 600 may determine a degradation state of the display panel 100 to correct the image data signal DTA.

FIG. 12 is a block diagram of a display system according to an exemplary embodiment.

FIG. 12 is a block diagram of a system 1000 including a timing controller 600 and a monitoring circuit 500, according to an exemplary embodiment. The monitoring circuit 600 and the timing controller 600 according to an exemplary embodiment may be included in a display driving circuit 20. According to an embodiment, the system 1000 may further include a memory 700. The system 1000 may be a computing system including a display apparatus 10. In a non-limiting embodiment, the system 1000 may be a stationary system such as a desktop computer, a server, a television (TV), or an electronic display board, or may be a mobile system such as a laptop computer, a mobile phone, a tablet personal computer (PC), or a wearable device. As illustrated in FIG. 12, the system 1000 may include a mother board 90 and the display apparatus 10, and the mother board 90 may communicate with the display apparatus 10 through a host channel HCH.

The mother board 90 may include a processor 91 and may function as a host of the display apparatus 10. In a non-limiting embodiment, the processor 91 may be referred to as a processing unit, performing a computational operation, such as a microprocessor, a microcontroller, an application specific integrated circuit (ASIC), or a field programmable gate array (FPGA). In some embodiments, the processor 91 may a video graphics processor such as a graphics processing unit (GPU). The processor 91 may generate image data corresponding to an image displayed by a display panel 100 included in the display apparatus 10, and the image data may be provided to the display apparatus 10 through the host channel HCH.

The display driving circuit may provide a data signal P_SIC and a scan signal S_SIG to the display panel 100 through signal lines (for example, a data line DL, a scan line SL, and/or the like). In the display driving circuit according to an embodiment, the monitoring circuit 500 may compensate for an error component included in a sensing current Isen sensed from the display panel 100 to transfer a sensing signal SEN to the timing controller 600, and thus, the timing controller 600 may correct image data signal DTA, thereby allowing the data driver 300 to provide the data signal P_SIC to the display panel 100.

The display driving circuit and the operating method thereof according to the exemplary embodiments may remove noise, an offset, and a leakage current causing an error of data needed for compensating for degradation, and thus, may accurately sense a degree of degradation, thereby precisely compensating for the degradation in the display panel.

While the inventive concept has been particularly shown and described with reference to embodiments thereof, it will be understood that various changes in form and details may be made therein without departing from the spirit and scope of the following claims.

What is claimed is:

1. A display driving circuit comprising:
an input control circuit configured to output an input current in response to a sensing current output from at least one pixel;
a sampling circuit configured to output a sampling voltage which is a reference voltage during a reset period, and which is a voltage varying based on the reference voltage and the input current during a signal period; and
an accumulating circuit configured to generate an output voltage by accumulating variation values of the sampling voltage, and provide the generated output voltage to an analog-to-digital converter (ADC) circuit,
wherein the sampling voltage decreases by a voltage decrement or increases by a voltage increment from the reference voltage according to the input current during the signal period.

2. The display driving circuit of claim 1, wherein the signal period comprises a first signal period and a second signal period, and
wherein the sampling voltage decreases by the voltage decrement based on the input current passing through a first current path during the first signal period, and increases by the voltage increment based on the input current passing through a second current path during the second signal period.

3. The display driving circuit of claim 2, wherein the input control circuit forms the first current path such that the input current flows in a forward direction from the input control circuit to the sampling circuit, and
wherein the input control circuit forms the second current path such that the input current flows in a direction opposite to the forward direction.

4. The display driving circuit of claim 3, wherein the input control circuit forms the second current path by applying a negative gain value to the sensing current.

5. The display driving circuit of claim 2, wherein the reference voltage corresponds to an offset and/or noise included in the sensing current, each of the voltage increment and the voltage decrement corresponds to a signal component of the sensing current, and the output voltage is generated by the accumulating circuit by removing the reference voltage from the sampling voltage.

6. The display driving circuit of claim 2, wherein each of the voltage increment and the voltage decrement is generated by applying the input current to a capacitor.

7. The display driving circuit of claim 2, wherein, during the first signal period, the reference voltage is a logic high voltage, and, during the second signal period, the reference voltage is a logic low voltage.

8. The display driving circuit of claim 2, wherein the reset period comprises a first reset period and a second reset period,
wherein the first reset period, the first signal period, the second reset period, and the second signal period sequentially configure one period in which an operation of sensing a degradation state of the pixel is performed, and
wherein, during the first reset period, the sampling voltage maintains a logic high voltage, and, during the second reset period, the sampling voltage maintains a logic low voltage.

9. The display driving circuit of claim 1, further comprising a timing controller,
wherein the ADC circuit digitizes the output voltage to provide a sensing signal to the timing controller, and
wherein the timing controller corrects an image data signal based on the sensing signal, and provides the corrected image data signal to a data driver generating a pixel signal for the pixel based on the corrected image data signal.

10. The display driving circuit of claim 1, further comprising:
a data driver; and
a timing controller,
wherein the ADC circuit digitizes the output voltage to provide a sensing signal to the timing controller, and the timing controller adjusts an image data signal, based on the sensing signal and provides an adjusted image data signal to the data driver.

11. A display driving circuit comprising:
a scan driver;
a data driver;
a sensing circuit configured to sense an input current from a display panel, comprising a plurality of pixels, through a monitor line; and
a timing controller configured to control the scan driver and the data driver such that a first pixel among the pixels outputs a sensing current to the monitor line during a first compensation period, and a second pixel among the pixels outputs a compensation current, based on the input current, to the monitor line during a second compensation period.

12. The display driving circuit of claim 11, wherein the first pixel and the second pixel are connected to different data lines and share one monitor line.

13. The display driving circuit of claim 12, wherein the timing controller controls the scan driver and the data driver such that the second pixel outputs the compensation current which is equal to or greater than an amount of a leakage current generated in a display driving circuit.

14. The display driving circuit of claim 11, wherein the sensing circuit obtains a difference between the input current obtained during the first compensation period and the input current obtained during the second compensation period as a final sensing current of the first pixel.

15. The display driving circuit of claim 14, wherein the final sensing current is a current from which a pixel leakage current obtained from a turned-off pixel is removed.

16. The display driving circuit of claim 15, wherein the timing controller controls the data driver to generate an image data signal for the first pixel based on the final sensing current.

17. The display driving circuit of claim 11, wherein the timing controller controls the scan driver to turn on the first pixel and the second pixel and turn off other pixels during the first compensation period, and to turn off the first pixel during the second compensation period, and
wherein the timing controller controls the data driver such that the first pixel outputs the sensing current to the monitor line during the first compensation period, and the second pixel outputs the compensation current to the monitor line during the first compensation period and the second compensation period.

18. The display driving circuit of claim 11, wherein the timing controller identifies the input current, measured from the sensing circuit during the second compensation period, as a pixel leakage current occurring in at least one turned-off pixel.

19. An operating method of a display driving circuit controlling a display panel including a plurality of pixels, the operating method comprising:
controlling a first pixel among the pixels to output a sensing current during a first compensation period;
sensing a first current flowing from a data pad, electrically connecting the display panel to the display driving circuit, to a sensing circuit included in the display driving circuit during the first compensation period;
sensing a first leakage current generated in a current path in the sensing circuit during the first compensation period;
controlling a second pixel among the pixels to output a compensation current corresponding to the first leakage current during the first compensation period;
sensing a second current flowing from the data pad to the sensing circuit during a second compensation period, where the first pixel is turned off, after the first compensation period; and
subtracting the second current from the first current to obtain a final sensing current.

20. The operating method of claim 19, further comprising:
changing a flow direction of a current output from the first pixel at a predetermined interval;
obtaining a sampling voltage based on the flow-direction-changed current;
accumulating variations of the sampling voltage during the predetermined interval to generate an output voltage; and
generating the sensing current based on the output voltage.
